(19) United States
(12) Patent Application Publication
(10) Pub. No.: US 2003/0135425 A1
(43) Pub. Date: Jul. 17, 2003

(54) Method and apparatus for a cryptographically assisted commercial system designed to facilitate seller driven sales offers

(76) Inventor: Harold O. Leavitt, Key Biscayne, FL (US)

Correspondence Address: MATTINGLY, STANGER & MALUR, P.C., 1800 DIAGONAL ROAD, SUITE 370, ALEXANDRIA, VA, 22314, US

(21) Appl. No.: 10/301,755

(22) Filed: Nov. 22, 2002

Related U.S. Application Data
(60) Provisional application No. 60/346,919, filed on Jan. 11, 2002.

(51) Int. Cl. G06F 17/60; H04K 1/00; H04L 9/00

(52) U.S. Cl. 705/26; 705/14; 705/37; 705/78

(57) ABSTRACT

The present invention is a method and apparatus for effectuating bilateral seller-driven commerce. The present invention is a method and apparatus for effectuating bilateral seller-driven commerce. The present invention allows prospective sellers of goods and services to communicate a conditional or binding selling offer globally through a third party to potential and specific buyers, and for buyers to potentially attempt to establish a contract based on the seller's conditional sales offer made to the third party or bind the seller to a contract based upon a binding selling offer made to the third party. The present invention is particularly novel and advantageous when the potential and specific buyers are recipients of Social Security benefits.

### FIELD OF THE INVENTION

The present invention is a method and apparatus for effectuating bilateral seller-driven commerce.

### BACKGROUND OF THE INVENTION

Various types of methods and apparatuses for effectuating commerce are known in the prior art. A general example of buyer-driven commerce is disclosed in U.S. Pat. Nos. 5,794,207 and 6,041,308 to Walker et al. The entire disclosures of these patents is hereby incorporated by reference.

Other examples are disclosed by U.S. Pat. No. 6,058,379 (Real-Time Network Exchange with Seller Specified Exchange Parameters and Interactive Seller Participation); U.S. Pat. No. 5,842,178 (Computerized Quotation System); U.S. Pat. No. 5,909,492 (Network Sales System); and U.S. Pat. No. 5,862,223 (Method and Apparatus for a Cryptographically-Assisted Commercial Network System Designed to Facilitate and Support Expert-Based Commerce). The entire disclosures of all of these patents are also incorporated by reference.

### BRIEF DESCRIPTION OF THE DRAWINGS

FIG. 1 illustrates an embodiment of the present invention.

### SUMMARY OF THE INVENTION

The present invention is a method and apparatus for effectuating bilateral seller-driven commerce. The present invention allows prospective sellers of goods and services to communicate a conditional selling offer globally through a third party to potential and specific buyers, and for buyers to potentially bind a seller to a contract based on the seller's conditional sales offer made to the third party. The present invention is particularly novel and advantageous when the potential and specific buyers discussed above are recipients of Social Security benefits.

### DETAILED DESCRIPTION OF THE PREFERRED EMBODIMENTS

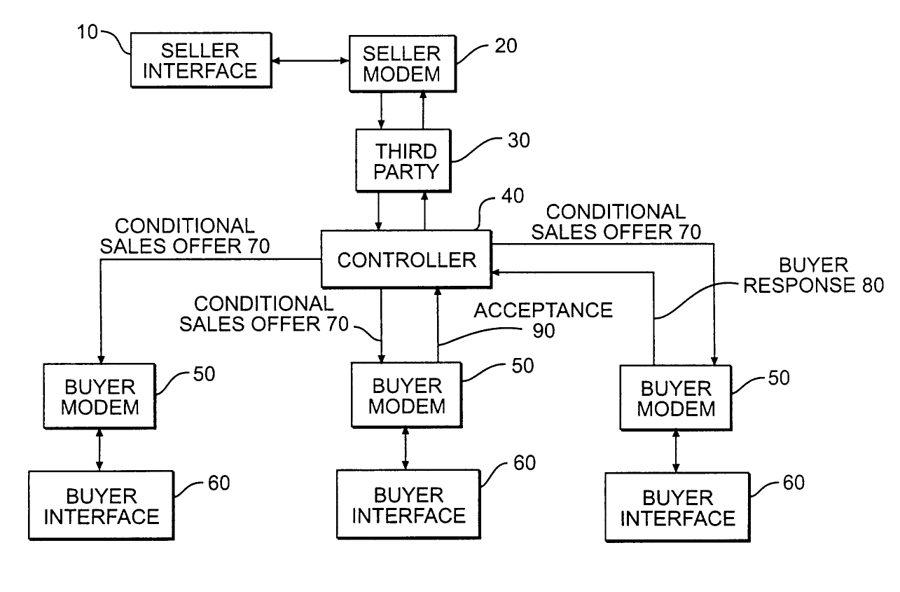

According to a preferred embodiment as shown in FIG. 1, the apparatus of the present invention includes a controller 40 of a third party 30 which receives and transmits conditional sales offers from prospective sellers via a seller interface 10 and a seller modem 20. Controller 40 may either be the third party's controller or any controller employed by the third party that is capable of satisfying the needs of the present invention. The controller 40 makes conditional sales offers globally and specifically to the potential and specific buyers via buyer modems 50 and buyer interfaces 60. The potential and specific buyers then have the option to accept the conditional sales offer in an attempt to establish a contract, or, to submit a conditional or binding counter-offer subject to seller's acceptance. Although the preferred embodiment specifies that the seller communicates conditional sales offers, it is also possible for the seller to communicate a binding sales offer which will bind the seller if a buyer accepts.

The method and apparatus of the present invention have applications on the internet as well as all conventional systems including voice telephony. Indeed, in the area of web-based cellular communications, the present invention may have an enormous impact in being able to reach numerous individuals in a short period of time. An object of the present invention is to allow either sellers or buyers to remain anonymous up until such time that agreement is consummated and for sellers or buyers to remain anonymous even after the agreement is consummated by using the trusted third party 30 as a relay system for delivery of goods or services called for by the seller's conditional (or binding) sales offer.

The present invention is particularly novel and advantageous when the potential and specific buyers discussed above are recipients of Social Security benefits. In this regard, proper receipt and encryption of Social Security numbers is essential since members of this class are protected under the Freedom of Information Act. The use of the third party greatly enhances the secrecy of any sales transactions that result.

According to the Census Bureau, it is estimated that there will be 70 million people 65 or older by the year 2030. Presently, the U.S. Government is grappling with the issue of maintaining sufficient funds. If the value of income received by this specific class of buyers is increased, the burden on the government will be greatly reduced. The cost of prescription drugs is increasing at an alarming rate, and much faster than any increase in social security benefits. Efforts by individual states to control prices have been thwarted by the courts which label such efforts as price controls. The present invention is not only applicable to drugs, but also to housing, food, clothing, travel, and leisure pursuits, etc. Due to the age of the above-mentioned specific class, there is no need to restrict offerings with respect to age. Canada, with about 10% of the population of the United States, controls similar medical expenses. Therefore, the specific class mentioned above should have no problem achieving the same leverage in the United States.

Security is always an important issue. Security measures should be undertaken including the use of fingerprint identification, social security numbers (encrypted) and PIN numbers. A point system can be used for discounts on all purchases, (i.e. travel, car, gas, insurance, food, liquor, etc.). In addition, the possibility of providing secondary insurance and housing as well as setting up a small business to make some additional cash could be enabled.

One way to implement the present invention is to establish one main or central company and also to establish a large number of franchises around the country, perhaps 100,000 franchises, covering areas of various sizes relative to the surrounding population. The company would manage the plurality of franchises in a hierarchical manner. While individuals can directly interact with the central company, the addition of franchises adds convenience.

Ex-servicemen and/or senior citizens collecting Social Security and ranging in age from 62 years old and above, could operate as franchisees out of their legion post, local school, library, home or other areas where they could receive, provide and/or distribute products ordered or required by people in the area, as well providing computer knowledge and use. For their service, such people would be assisted in securing financing on their behalf when required from the Small Business Administration, government incentive loans or regular bank loans.

A franchisee could own or supervise up to 10 franchises and would be responsible for their adherence to policies. All franchisees would report to and be responsible to one franchiser. Under one scenario, ten franchisers would report to one company marketing manager. Ten marketing managers would report to one vice president of marketing of the company. Finally, under this scenario, ten vice presidents of marketing would report to one director of the company board. All franchisees would be interconnected via computer and telephone systems with each other, their supervisor, and the company home office. Any franchise could be canceled depending upon circumstances, such as for cause.

One main purpose of the present invention is to bring discounted medications, home and/or office products, travel, insurance, leisure products and any and all products required by recipients of Social Security. Another goal is to hire and assist people involved in the community to assure company shareholders of the company's integrity, honesty, and good faith.

While the present invention has been disclosed in connection with the preferred embodiments, one of ordinary skill in the art would be enabled by this disclosure to make various modifications to these embodiments and still be within the scope and spirit of the present invention as recited in the claims.

What is claimed is:

1. A method of effectuating bilateral seller-driven commerce comprising a plurality of sellers, buyers and at least one independent third party through which the sellers and buyers communicate comprising the steps of:
at the third party, receiving and transmitting conditional sales offers from perspective sellers to potential and specific buyers;
permitting the potential and specific buyers to accept any of the conditional sales offers in an attempt to establish a contract; and
permitting the buyer, as an alternative to accepting the conditional sales offer, to submit a conditional or binding counter-offer,
wherein the potential and specific buyers are recipients of Social Security benefits.

2. The method according to claim 1, wherein the independent third party insures the anonymity of the sellers and the buyers during the entirety of the making of the contract.

3. A method of effectuating bilateral seller-driven commerce comprising a plurality of sellers, buyers and at least one independent third party through which the sellers and buyers communicate comprising the steps of:
at the third party, receiving and transmitting binding sales offers from perspective sellers to potential and specific buyers;
permitting the potential and specific buyers to accept any of the binding sales offers and thus bind the corresponding seller to a contract; and
permitting the buyer, as an alternative to accepting the binding sales offer, to submit a conditional or binding counter-offer,
wherein the potential and specific buyers are recipients of Social Security benefits.

4. The method according to claim 3, wherein the independent third party insures the anonymity of the sellers and the buyers during the entirety of the making of the contract.
